(19) United States
(12) Patent Application Publication
(10) Pub. No.: US 2020/0387848 A1
(43) Pub. Date: Dec. 10, 2020

(54) Decreasing Core Attrition and Deriving Effective Action Steps Using Impactful Surveys

(71) Applicant: International Business Machines Corporation, Armonk, NY (US)

(72) Inventors: Jyotsna Kasa, Visakhapatnam (IN); Saraswathi Sailaja Perumalla, Visakhapatnam (IN); Malathy Desikan, Visakhapatnam (IN); Suresh Pemmireddy, Visakhapatnam (IN); Venkata Vara Prasad Karri, Visakhapatnam (IN)

(21) Appl. No.: 16/433,628

(22) Filed: Jun. 6, 2019

(51) Int. Cl. G06Q 10/06; G06Q 10/10; G06F 16/35; G06F 16/33

(52) U.S. Cl. CPC G06Q 10/06393; G06Q 10/105; G06F 16/3344; G06F 16/3334; G06F 16/353

(57) ABSTRACT

Generating insights and action steps based on analyzing employee survey results is provided. Responses to an employee survey are received from each respective set of employees having specific tagged attributes in each defined entity category. A current employee survey result for each respective set of employees is generated based on the responses received from each respective set of employees having the specific tagged attributes in each defined entity category. The current employee survey result is compared with historic survey results corresponding to each respective set of employees. An employee survey result report with insights and action steps is generated for each respective set of employees based on comparing the current employee survey result with the historic survey results corresponding to each respective set of employees. The employee survey result report with insights and action steps for each respective set of employees is displayed in a set of user interfaces.

### BACKGROUND

### 1. Field

The disclosure relates generally to employee surveys and more specifically to decreasing core contributing employee attrition by generating insights and action steps based on analyzing employee survey results of core groups of contributing employees having specific employee attributes corresponding to defined organizational categories.

### 2. Description of the Related Art

Commitment and loyalty of employees can make or break any organization. Both commitment and loyalty may rely on how these employees are treated in day to day operations. Some employees may complain about low wages, while others may have concerns about a supervisor. In addition, some employees may even worry about health hazards in the workplace.

An employee survey may be the answer to uncovering such hidden concerns or complains. Employee surveys are tools used by organizations to gain feedback on and measure employee engagement, morale, and performance. Usually answered anonymously, employee surveys are also used to gain a holistic picture of employees' feelings on categories such as working conditions, supervisory impact, motivation, and the like that regular channels of communication may not uncover. Main-line survey providers have traditionally used similar survey question types and survey length over the course of years and throughout various industries. Comparison databases provide standard ranges on which certain factors can be placed, as well as correlations between coexisting factors (allowing for emphasis on the factor with highest correlation to a desired outcome). In contrast, the advent of survey software, particularly online programs, has given organizations tools to design and conduct their own employee surveys.

### SUMMARY

According to one illustrative embodiment, a computer-implemented method for generating insights and action steps based on analyzing employee survey results is provided. A computer receives responses to an employee survey of an entity from each respective set of employees having specific tagged attributes in each defined entity category. The computer generates a current employee survey result for each respective set of employees based on the responses received from each respective set of employees having the specific tagged attributes in each defined entity category. The computer compares the current employee survey result with historic survey results corresponding to each respective set of employees. The computer generates an employee survey result report with insights and action steps for each respective set of employees based on comparing the current employee survey result with the historic survey results corresponding to each respective set of employees. The computer displays the employee survey result report with insights and action steps for each respective set of employees in a set of one or more user interfaces. According to other illustrative embodiments, a computer system and computer program product for generating insights and action steps based on analyzing employee survey results are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of an employee survey analysis process in accordance with an illustrative embodiment;

FIG. 4 is a diagram illustrating an example of an employee survey response separation process in accordance with an illustrative embodiment;

FIG. 5 is a diagram illustrating an example of data flow in accordance with an illustrative embodiment;

FIG. 6 is a flowchart illustrating a process for tagging employee attributes and deriving organization category results based on attribute tagged groups of employees in accordance with an illustrative embodiment;

FIG. 7 is a flowchart illustrating a process for calculating a total employee survey response score based on different aspects corresponding to an employee in accordance with an illustrative embodiment;

FIG. 8 is a flowchart illustrating a process for understanding trends in employee survey responses after shifts in an organization in accordance with an illustrative embodiment; and

FIGS. 9A-9B are a flowchart illustrating a process for generating an employee survey result report in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

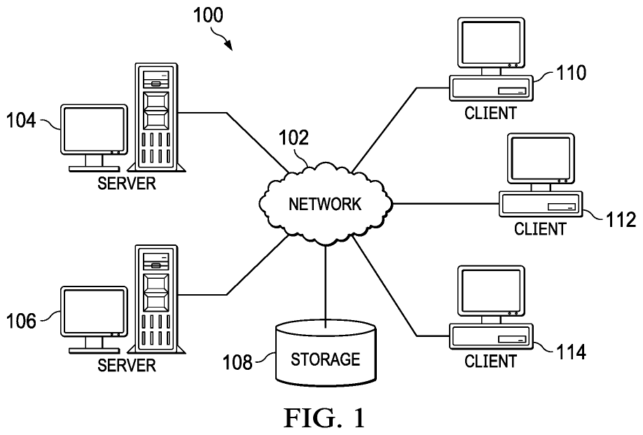

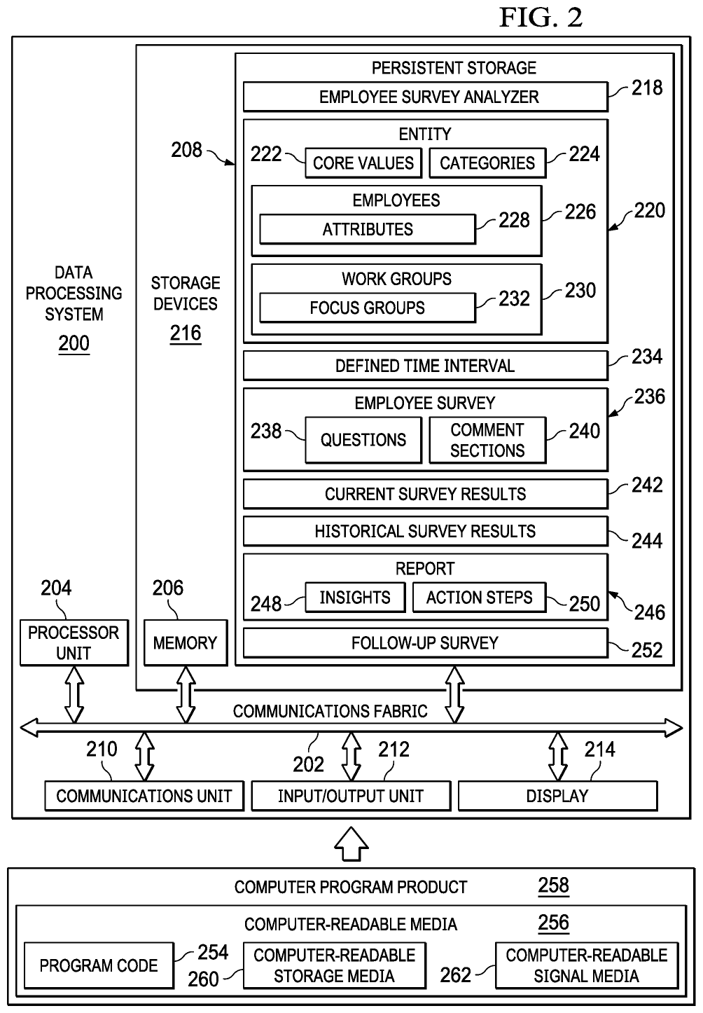

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 are, for example, server computers with high-speed connections to network 102. In addition, server 104 and server 106 provide employee survey analysis services for one or more entities, such as organizations, business, institutions, agencies, and the like. Server 104 and server 106 provide the employee survey analysis services by analyzing received employee survey responses from a set of one or more core groups of contributing employees having specified employee attributes corresponding to defined entity categories and generating a report that includes insights and action steps to address employee concerns noted in the responses and thereby decrease employee attrition (e.g., flight risk) based on the analysis of the responses.

Also, it should be noted that server 104 and server 106 may each represent a cluster of servers in one or more data centers. Alternatively, server 104 and server 106 may each represent computing nodes in one or more cloud environments that provide employee survey analysis services. Further, server 104 and server 106 may be owned and operated by one or more entities or may be owned and operated by a third-party service.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, laptop computers, handheld computers, smart phones, smart watches, smart televisions, kiosks, and the like. Users of clients 110, 112, and 114 may utilize clients 110, 112, and 114 to utilize the employee analysis services provided by server 104 and server 106. For example, users of clients 110, 112, and 114 may automatically receive employee surveys from server 104 and server 106 on a predetermined time interval basis and then submit responses to the employee survey questions via clients 110, 112, and 114. In addition, supervisory users, such as managers, of clients 110, 112, and 114 may receive from server 104 and server 106 employee survey result reports that include insights and action steps corresponding to work groups or business units of each respective supervisory user. Further, server 104 and server 106 may provide other information to clients 110, 112, and 114 such as programs, applications, software updates, software fixes, and the like.

Storage 108 is a network storage device capable of storing any type of data in a structured format or an unstructured format. In addition, storage 108 may represent a plurality of network storage devices. Further, storage 108 may store identifiers and network addresses for a plurality of employee survey analysis servers, identifiers and network addresses for a plurality of different client devices, identifiers for a plurality of different client device users (e.g., employees), employee surveys, historical employee survey result reports, and the like. Furthermore, storage 108 may store other types of data, such as authentication or credential data that may include user names, passwords, and biometric data associated with client device users and system administrators, for example.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), a telecommunications network, or any combination thereof. FIG. 1 is intended as an example only, and not as an architectural limitation for the different illustrative embodiments.

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments may be located. Data processing system 200 contains or controls a set of one or more unused resources that are available for use by other resource provider data processing systems. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random-access memory (RAM), or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores employee survey analyzer 218. However, it should be noted that even though employee survey analyzer 218 is illustrated as residing in persistent storage 208, in an alternative illustrative embodiment employee survey analyzer 218 may be a separate component of data processing system 200. For example, employee survey analyzer 218 may be a hardware component coupled to communication fabric 202 or a combination of hardware and software components. In another alternative illustrative embodiment, a first set of components of employee survey analyzer 218 may be located in data processing system 200 and a second set of components of employee survey analyzer 218 may be located in a second data processing system, such as, for example, server 106 in FIG. 1.

Employee survey analyzer 218 controls the process of analyzing responses to survey questions by employees having a set of specified employee attributes and then generating a report that includes insights and action steps to address employee concerns noted in the responses based on the analysis of the responses. Entity 220 represents an identifier of an organization, business, institution, agency, or the like that includes a plurality of employees. Also, it should be noted that entity 220 may represent identifiers for a plurality of different entities.

Employee survey analyzer 218 identifies core values 222 of entity 220 based on core value data corresponding to entity 220 found in one or more local and/or remote databases. Entity core values may be, for example, honesty, integrity, customer-oriented, and the like. Categories 224 represent a plurality of predefined entity categories, such as, employee engagement, employee productivity, employee retention, manager effectiveness, facilities, resources, and the like. Employees 226 represent a list of all employees corresponding to entity 220 and include any type of employee from lowest-level employee to highest-level employee. Attributes 228 represent a set of one or more characteristics, qualities, traits, and the like that correspond to each respective employee in employees 226. Work groups 230 represent different sets of employees that form teams, business units, and the like within entity 220. A set of employees of one work group may have similar attributes, such as, for example, tagged as software developers. Focus groups 232 represent subsets of employees within work groups 230. In other words, a focus group within a particular work group is a core subset of employees having specified attributes, such as high employee productivity scores, that have a greater impact on entity 220 business.

Defined time interval 234 represents a predefined interval of time, such as, for example, six months, one year, or the like, for automatically sending employee survey 236 to employees 226 or focus groups 232. In addition, it should be noted that defined time interval 234 may include other predefined intervals of time, such as, for example, one month, three months, or the like, for automatically sending follow up survey 252 to employees 226 or focus groups 232.

Employee survey 236 includes questions 238 and comment sections 240. Questions 238 represent a plurality of different questions corresponding to one or more of categories 224. Comment sections 240 represent areas within employee survey 236 where an employee may insert comments or concerns with regard to one or more particular questions in questions 238.

Employee survey analyzer 218 generates current survey results 242 based on analyzing received responses to questions 238 and comments sections 240 in employee survey 236 while considering categories 224 and attributes 228. Historical survey results 244 represent results of previous employee surveys over a defined period of time or within defined parameters. Employee survey analyzer 218 compares current survey results 242 with historical survey results 244 to identify trends and patterns. Further, employee survey analyzer 218 compares current survey results 242 with historical survey results 244 to identify increases and decreases in employee response scores corresponding to, for example, employee engagement, positivity, satisfaction, flight risk, and the like.

Employee survey analyzer 218 generates report 246 based on the comparison of current survey results 242 and historical survey results 244. Report 246 includes insights 248 and action steps 250. Employee survey analyzer 218, via machine learning, generates insights 248 based on understanding the identified trends and patterns and reasons for the increases and decreases in the employee response scores. Action steps 250 represent a set of one or more actions that may be taken to mitigate or address employee concerns or problems noted in insights 248 of current survey results 242. Employee survey analyzer 218 automatically sends follow up survey 252 after a predefined interval of time to determine whether action steps 250 appropriately addressed employee concerns or if further action is needed.

As a result, data processing system 200 operates as a special purpose computer system in which employee survey analyzer 218 in data processing system 200 enables analyzing survey question responses received from employees having a set of specified employee attributes corresponding to defined entity categories and generating an employee survey result report that includes insights and action steps to address employee concerns noted in the survey question responses. In particular, employee survey analyzer 218 transforms data processing system 200 into a special purpose computer system as compared to currently available general purpose computer systems that do not have employee survey analyzer 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 254 is located in a functional form on computer readable media 256 that is selectively removable and may be loaded onto or transferred to data processing system 200 for running by processor unit 204. Program code 254 and computer readable media 256 form computer program product 258. In one example, computer readable media 256 may be computer readable storage media 260 or computer readable signal media 262. Computer readable storage media 260 may include, for example, an optical or magnetic disc that is inserted or placed into a drive or other device that is part of persistent storage 208 for transfer onto a storage device, such as a hard drive, that is part of persistent storage 208. Computer readable storage media 260 also may take the form of a persistent storage, such as a hard drive, a thumb drive, or a flash memory that is connected to data processing system 200. In some instances, computer readable storage media 260 may not be removable from data processing system 200.

Alternatively, program code 254 may be transferred to data processing system 200 using computer readable signal media 262. Computer readable signal media 262 may be, for example, a propagated data signal containing program code 254. For example, computer readable signal media 262 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 254 may be downloaded over a network to persistent storage 208 from another device or data processing system through computer readable signal media 262 for use within data processing system 200. For instance, program code stored in a computer readable storage media in a data processing system may be downloaded over a network from the data processing system to data processing system 200. The data processing system providing program code 254 may be a server computer, a client computer, or some other device capable of storing and transmitting program code 254.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 260 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Typically, employee survey results do not provide insights into potential employee flight risks. Further, it is important to determine from employee surveys whether a particular group of employees with certain attributes, who have an impact on revenue, future business, and the like, are happy and motivated employees. Furthermore, it is important to determine whether new employees as compared to established employees in a manager's work group are promoters or detractors. Moreover, it is important to determine whether the correct insights are being gleaned from employee surveys to identify appropriate action steps to address employee concerns or problems.

Illustrative embodiments identify a set of employees who impact an organization by their new ideas, strategies, and innovations. Illustrative embodiments then associate the set of employees with a defined category, such as “business influencers”. Survey results from such employees make a greater impact on the organization as they are leaders for organizational growth. Collecting separate data points for an entire work group that includes the set of employees are useful for focusing on planning action steps specific to that specific work group. Moreover, managers and supervisors will have more robust data by looking at a more detailed survey result report at specific work group levels (e.g., overall work group, a set of employees within the work group, and the like).

A sudden drop in employee survey result scores corresponding to a particular manager whose work group was previously the most motivated work group in the organization may be an indication of a particular employee problem or concern. Illustrative embodiments provide this indication in an employee survey result report of an upline manager that includes a comparison over the past several years for the same work group. The employee survey result report should cause the upline manager to investigate the reason for the sudden drop in scores, as the drop may be the effect of a new manager on the work group.

Illustrative embodiments identify decreases or increases in employee survey result scores due to new or established employees in a work group who joined on or after a specific point in time, not compromising employee anonymity, which helps a manager to identify the manager's focus group (e.g., set of most influential employees in a work group) for any action plan. Survey result insights that a manager needs to know are the pulse of the manager's work group, separating between new and established employees. For example, sometimes it is challenging for a manager to know which employees (new or established) are dragging the manager's survey result scores down against wrong assumptions.

Typically, organizations give repetitive employee surveys over a year's time to the same set of employees each time. However, illustrative embodiments provide follow up questions rather than repeating the same questions to ensure differentiated, relevant survey results to know impact of action steps taken. For example, illustrative embodiments may ask a follow up survey question, such as did employees notice whether actions were taken regarding the employees' feedback from the last survey, which may be generic but is not too specific of a follow up question on employee feedback regarding a concern, such facilities improvements, challenging work environment, and the like.

The following provides several use case scenarios. For each work group (e.g., business unit) in an organization, illustrative embodiments identify a focus group (e.g., a set of most influential or impactful employees to the organization), who may comprise, for example, approximately 10% of each work group, prior to employees taking a survey. Illustrative embodiments may associate each identified focus group of employees from each work group with one or more defined categories. In addition, illustrative embodiments may provide the employee survey result scores of each work group for review at a top executive level or at any defined supervisory level based on organizational hierarchy. Organizations make important decisions based on employee survey results of these focus groups for the betterment of these organizations. For example, survey responses from a focus group may concentrate on getting more promotion opportunities, whereas survey responses from a generic set of employees may focus on pay increases. As a result, illustrative embodiments may determine that pay is not a primary concern of the focus group as compared to the generic set of employees and that giving the focus group more promotion opportunities, challenges, and priority is a needed action plan for this group's engagement to bring about a greater impact on the organization.

As another use case scenario, a new manager joins an established work group. If the new manager is aggressive or possesses an undesirable trait, which the work group may not have experienced in the past, the work group may become less motivated and, as a result, provide negative survey responses. This may go unnoticed as the lower score is generally perceived as a first-time score with nothing to compare it to. However, illustrative embodiments provide survey result insights to an upline manager of the same work group by comparing the work group's current survey result score to last year's score, even though under different managers, which can be taken as a matter of concern focusing on the reason for the lower score. When such survey results go unnoticed, this may lead to employee flight risk. This may be because even though employees took the time to highlight their concerns, management could not differentiate the reasons for the change in scores. Consequently, the organization may run the risk of losing one or more valued employees. Illustrative embodiments are able to reduce employee flight risk by providing valuable insights into the employee survey results, while maintaining employee anonymity.

A variation of the use case scenario above may be that the same manager is placed over a new work group and the current employee survey result report shows a decrease in the manager's score. The manager may assume that the decrease in score is due to members of the new work group, who have not yet understood the manager's work culture for the group. As a result, the manager may ignore the employee survey result report. However, illustrative embodiments indicate the employee survey result corresponding to the manager by differentiating overall employee response scores from new work group member responses and established work group member responses in total, which may provide the manager with new insights into the actual reason for the lower score. For example, the lower score may actually be due to established member responses of the work group, and when the manager reviews the insights provided by illustrative embodiments, the manager may realize that the lower score is due to the established members feeling that their significance in the work group has been reduced due to the presence of the new members. Consequently, the manager may start prioritizing between new and established members of the work group for increased productivity and an increased sense of member significance, thus improving future employee survey result scores for the manager.

Some organizations utilize mini pulse surveys with a frequency of, for example, monthly, quarterly, semi-annually, and the like, based on particular needs of these organizations. When an organization decides to send multiple surveys within a one-year time period, for an identified work group, at regular intervals, to increase impact at each interval, the organization should not include the same questions in the employee survey each time. Illustrative embodiments generate and utilize follow up questions to understand actual impact of action steps taken after each employee survey. However, it should be noted that illustrative embodiments may not send the follow up questions to the exact same or identical set of employees due to workgroup membership changes (e.g., employee attrition and the like).

For example, if an employee survey includes a question, such as “How would you rate the facilities in your workplace?”: Excellent, Very Good, Good, Neutral, Poor, Very Poor, Terrible. A result of the employee survey may indicate that most responses to that question where either Good or Poor, with written comments on how to improve the provided food facilities of the workplace. After implementing one or more action steps to improve the food facilities based on the survey responses, illustrative embodiments send a follow up employee survey after expiration of a defined time interval. In the follow up employee survey, illustrative embodiments may include follow up questions, such as “Have you noticed changes in the food facilities in your workplace?”; “Has your rating of the food facilities changed since the last survey?”; “How would you rate the cost of the food that is being provided in the food facility?”; “How would you rate the quality of the food?”; and the like. By changing the employee survey format to include specific follow up questions, illustrative embodiments are able to determine the effectiveness of action steps taken in those specific areas of employee concern and identifying whether those specific areas of concern have been satisfactorily addressed or still need improvement.

Illustrative embodiments identify a set of core values, such as, for example, customer satisfaction, responsiveness, exceed expectations, respect, results-oriented, quality, integrity, honesty, and the like, corresponding to an organization. Illustrative embodiments then associate each employee of the organization with one or more core values of the organization. Afterward, illustrative embodiments place each employee into one or more defined categories, such as, for example, business, facility, salary, opportunity, technology, resources, administration, employee engagement, priority, and the like, based on associated core values and tagged employee attributes assigned by an employee's supervisor, such as, for example, a manager. However, it should be noted that illustrative embodiments may automatically tag an employee with one or more defined attributes based on, for example, supervisor reviews, human resource data, behavioral assessment tests, employee performance awards, and the like. Employee attributes may include, for example, technology savvy, salary oriented, inspirational, aspirational, proactive, creative, reactive, introverted, extroverted, risk taker, dependable, self-motivated, enthusiastic, optimistic, flexible, team-oriented, problem solver, and the like.

Further, illustrative embodiments identify a set of employees having specific employee attributes in each defined category as a focus group. Illustrative embodiments send an employee survey to each focus group at defined time intervals. Subsequently, illustrative embodiments receive responses to the employee survey from each focus group.

Illustrative embodiments then analyze the received responses to the employee survey and separate the received responses based on defined categories and tagged employee attributes. For example, if a survey response to a question in a salary category is rated low by a technology savvy attribute tagged employee, then illustrative embodiments may determine that the technology savvy employee has not considered salary as a concern up to now. In addition, illustrative embodiments may also determine that the technology savvy employee may become unhappy if low or no technical challenges or opportunities are provided to the technology savvy employee. Further, illustrative embodiments may determine from survey responses that the technology savvy employee is not happy with assigned technology initiatives or new project technologies. Illustrative embodiments may ensure that survey results of the technology savvy employee align with strategic imperatives. And when it comes to leadership, illustrative embodiments may ensure that different challenges related to business and resource-related categories takes priority.

Illustrative embodiments then display to leadership and management a survey result report showing insights into responses provided by each focus group of employees. Moreover, illustrative embodiments generate action steps to take based on the generated insights into the received responses. Further, these generated insights and action steps may be utilized on a location-wide, division-wide, or business unit-wide basis providing increased understanding of organizational progression because employees contribute to the ultimate success of the organization. Furthermore, illustrative embodiments may perform a historical survey result comparison, considering employee attributes, when there are organizational-wide changes, such as, for example, unifying service models, gaining acquisitions, divesting resources, changing business units, changing leadership, changing technology, and the like, to ensure that the organization is continuing on a correct path for continued success.

Survey engagement of a core focus group of employees, even though given the same survey questions, is more relevant to an organization. Reviewing survey results amongst low, medium, and top contributing employees of an organization and taking action steps based on the all-inclusive survey results may not make a significant impact on the organization. However, a core focus group, like technology savvy leaders, innovators, and the like, are the ones who perform above and beyond expectations and make a bigger impact on the organization. As a result, it is important to survey different core focus groups of an organization for greater impact. In addition, it is important for a manager to keep the manager's core focus group intact (e.g., prevent employee flight risk) for the betterment of the organization by taking action steps that illustrative embodiments included in the survey result report corresponding to the core focus group.

Previously, identifying employee flight risk has been more subjective based on a manager's one-on-one interactions with employees and observed behaviors. However, an employee taking an anonymous survey may provide illustrative embodiments with hints as to employee flight risk, especially when illustrative embodiments consider specific categories, such as, for example, salary or managerial style. When illustrative embodiments compare the current survey result, which shows a decrease in score, with previous survey results for the same set of employees, who are now reporting to a different manager and their job roles have not changes, illustrative embodiments may determine that disengagement of these employees is due to the new manager. As a result, illustrative embodiments may provide action steps for the manager to correct the current situation and decrease employee flight risk. Preventing employee attrition has a direct impact on revenue to the organization, reduces costs associated with new hires, such as training, and maintains productivity.

Any generic action plan that is based on wrong assumptions gleaned from survey results of a large group of employees, where established and new employees with different attributes carry the same weight, may not be fruitful to the organization. For example, if a manager implements the generic action plan based on the wrong assumptions, then the manager may focus on the wrong group of employees (e.g., the new employees instead of the established employees) causing further employee de-motivation and decreased productivity, with more client issues, such as software bugs, which were not issues previously. Any negative client impact due to the action plan will have a direct impact on renewals. Hence, it is extremely important for managers to rightly know who and what are the reasons for decreases in employee survey result scores. Illustrative embodiments generate insights and a set of action steps, which are based on analyzing survey results corresponding to core focus groups with certain employee attributes, for managers to review and implement to decrease employee concerns, correct problems, and decrease employee flight risk.

Thus, illustrative embodiments provide one or more technical solutions that overcome a technical problem with analyzing survey question responses received from employees having a set of specified employee attributes corresponding to defined entity categories and generating an employee survey result report that includes insights and action steps to address employee concerns noted in the survey question responses. As a result, these one or more technical solutions provide a technical effect and practical application in the field of employee survey response data analysis.

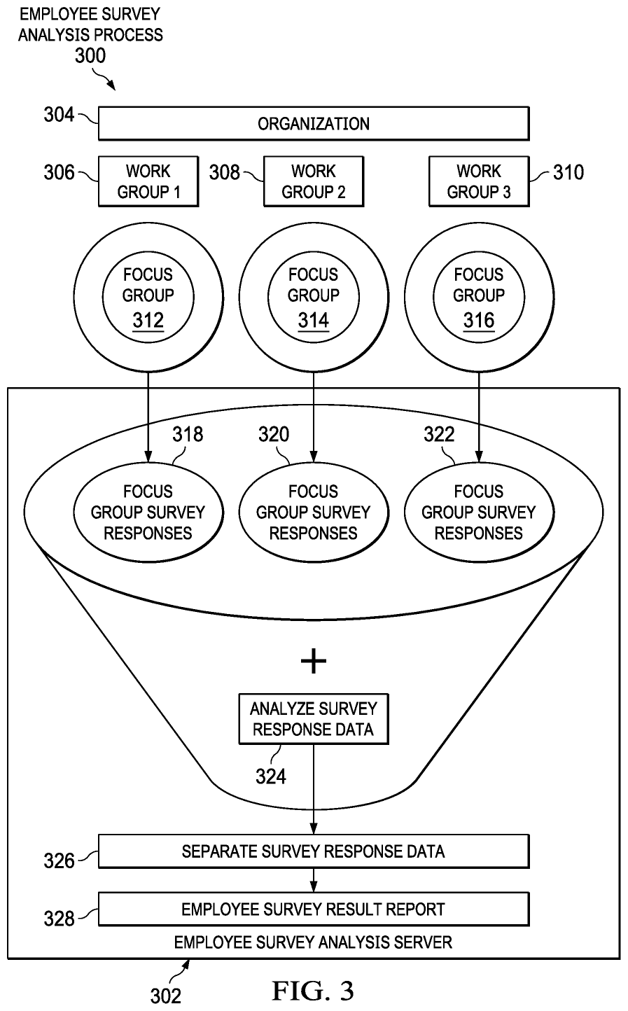

With reference now to FIG. 3, a diagram illustrating an example of an employee survey analysis process is depicted in accordance with an illustrative embodiment. Employee survey analysis process 300 is implemented in employee survey analysis server 302, such as, for example, server 104 in FIG. 1 or data processing system 200 in FIG. 2. Employee survey analysis server 302 is a data processing system consisting of hardware and software components for analyzing survey question responses received from employees having a set of specified employee attributes corresponding to defined entity categories and generating an employee survey result report that includes insights and action steps to address employee concerns noted in the survey question responses and, thereby, decrease employee flight risk.

In this example, employee survey analysis server 302 provides employee survey analysis services for organization 304. Organization 304 may represent any type of organization and may be, for example, entity 220 in FIG. 2. Organization 304 includes a plurality of employees and is divided into work group 1 306, work group 2 308, and work group 3 310. However, it should be noted that organization 304 may be comprised of any number of work groups.

Employee survey analysis server 302 selects focus group 312, focus group 314, and focus group 316 from work group 1 306, work group 2 308, and work group 3 310, respectively, based on specified employee attributes, employee goals, organization categories, and the like. Employee survey analysis server 302 automatically sends an employee survey to focus group 312, focus group 314, and focus group 316 on expiration of a defined time interval. Subsequently, employee survey analysis server 302 receives focus group survey responses 318, focus group survey responses 320, and focus group survey responses 322 from focus group 312, focus group 314, and focus group 316, respectively.

At 324, employee survey analysis server 302 analyzes the survey response data. At 326, employee survey analysis server 302 separates the survey response data based on specified employee attributes, employee goals, organization categories, and the like. At 328, employee survey analysis server 302 generates an employee survey result report that includes insights and action steps for each respective work group. The employee survey result report including insights and action steps may be, for example, report 246 that includes insights 248 and action steps 250 in FIG. 2.

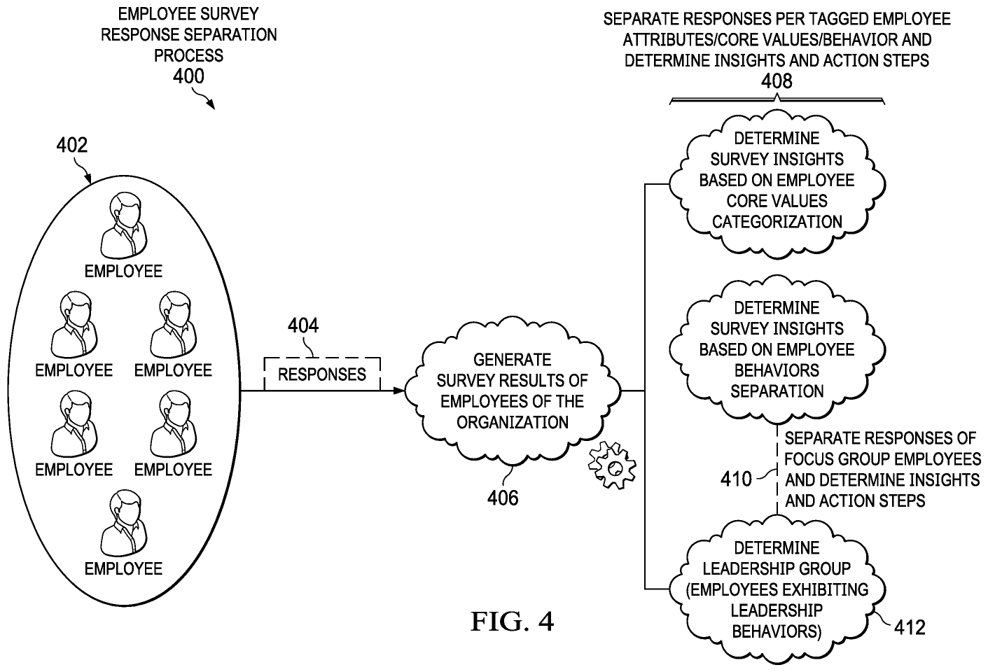

With reference now to FIG. 4, a diagram illustrating an example of an employee survey response separation process is depicted in accordance with an illustrative embodiment. Employee survey response separation process 400 may be implemented in a computer, such as, for example, server 104 in FIG. 1, data processing system 200 in FIG. 2, or employee survey analysis server 302 in FIG. 3.

Employees 402 send responses 404 to an employee survey. At 406, employee survey response separation process 400 generates survey results of employees of the organization. At 408, employee survey response separation process 400 separates responses based on tagged employee attributes, core values, behavior, and the like and determines insights and action steps for the organization. At 410, employee survey response separation process 400 separates responses of focus group employees and determines insights and action steps for each respective focus group. At 412, employee survey response separation process 400 determines a leadership group (i.e., employees exhibiting leadership behaviors) from the focus groups.

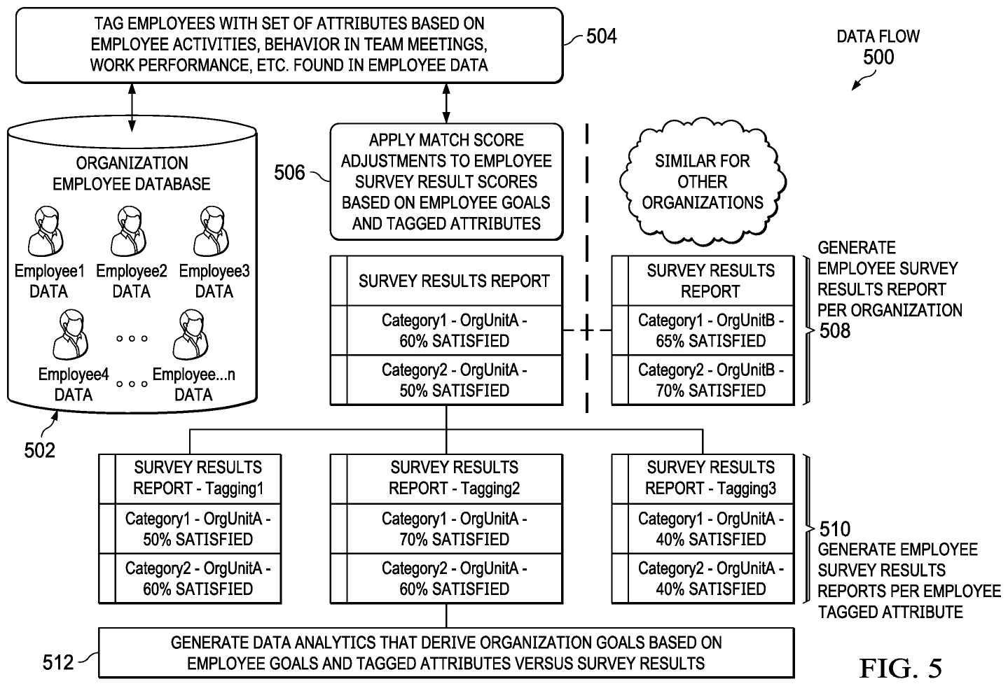

With reference now to FIG. 5, a diagram illustrating an example of data flow is depicted in accordance with an illustrative embodiment. Data flow 500 may be implemented in a computer, such as, for example, server 104 in FIG. 1, data processing system 200 in FIG. 2, or employee survey analysis server 302 in FIG. 3. Data flow 500 retrieves employee data from organization employee database 502 that contains information regarding a plurality of employees corresponding to a particular entity.

At 504, data flow 500 tags employees with a set of one or more defined attributes based on, for example, employee activities, employee behavior in team/work group meetings, employee work performance, and the like, found in the employee data retrieved from organization employee database 502. At 506, data flow 500 applies match score adjustments to employee survey result scores based on employee goals and tagged attributes. At 508, data flow 500 generates an employee survey results report for each respective organization. At 510, data flow 500 generates employee survey results reports for each respective employee tagged attribute. At 512, data flow 500 generates data analytics that derive organization goals based on employee goals and tagged attributes versus survey results.

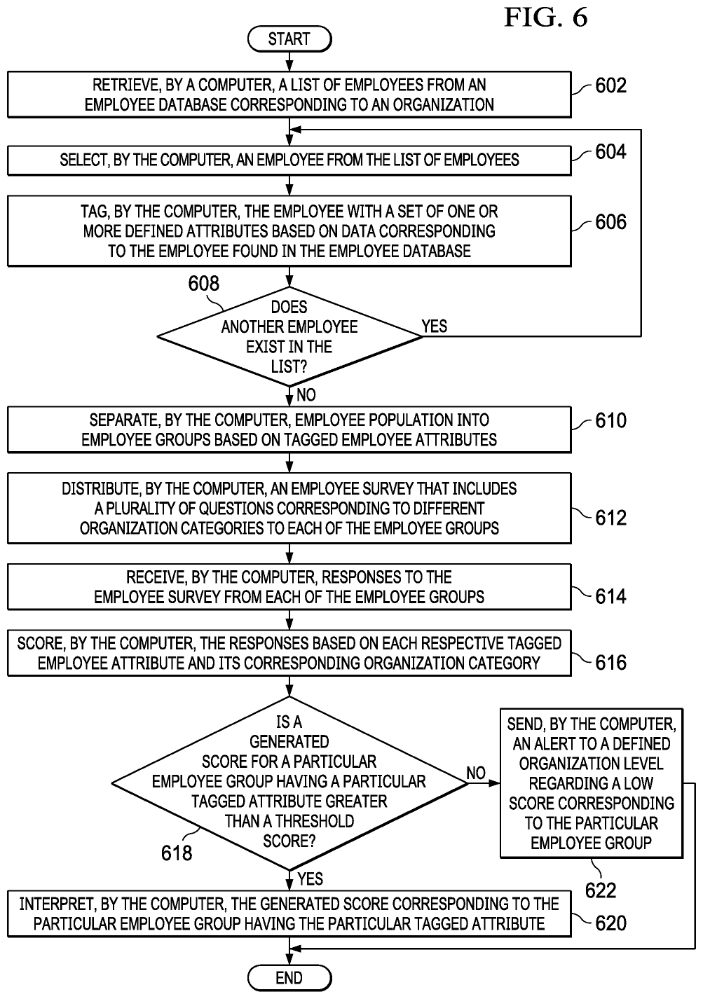

With reference now to FIG. 6, a flowchart illustrating a process for tagging employee attributes and deriving organization category results based on attribute tagged groups of employees is shown in accordance with an illustrative embodiment. The process shown in FIG. 6 may be implemented in a computer, such as, for example, server 104 in FIG. 1, data processing system 200 in FIG. 2, or employee survey analysis server 302 in FIG. 3.

The process begins when the computer retrieves a list of employees from an employee database corresponding to an organization (step 602). The computer selects an employee from the list of employees (step 604). The computer tags the employee with a set of one or more defined attributes based on data corresponding to the employee found in the employee database (step 606). The defined employee attributes may be, for example, technology savvy, proactive, inspirational, risk-taker, innovative, and the like.

The computer makes a determination as to whether another employee exists in the list of employees (step 608). If the computer determines that another employee does exist in the list of employees, yes output of step 608, then the process returns to step 604 where the computer selects another employee in the list of employees. If the computer determines that another employee does not exist in the list of employees, no output of step 608, then the computer separates the employee population into employee groups based on tagged employee attributes (step 610).

Afterward, the computer distributes an employee survey that includes a plurality of questions corresponding to different organization categories to each of the employee groups (step 612). The different organization categories may include, for example, employee engagement, employee retention, manager effectiveness, and the like. Subsequently, the computer receives responses to the employee survey from each of the employee groups (step 614). The computer scores the responses based on each respective tagged employee attribute and an organization category corresponding to each respective tagged employee attribute (step 616).

The computer makes a determination as to whether a generated score for a particular employee group having a particular tagged attribute is greater than a score threshold level (step 618). If the computer determines that the generated score for the particular employee group having the particular tagged attribute is greater than the score threshold level, yes output of step 618, then the computer interprets the generated score corresponding to the particular employee group having the particular tagged attribute (step 620). Thereafter, the process terminates. If the computer determines that the generated score for the particular employee group having the particular tagged attribute is not greater than the score threshold level, no output of step 618, then the computer sends an alert to a defined organization level regarding a low score corresponding to the particular employee group (step 622). The defined organization level may be, for example, a work group level, a division level, an organization level, and the like. Thereafter, the process terminates.

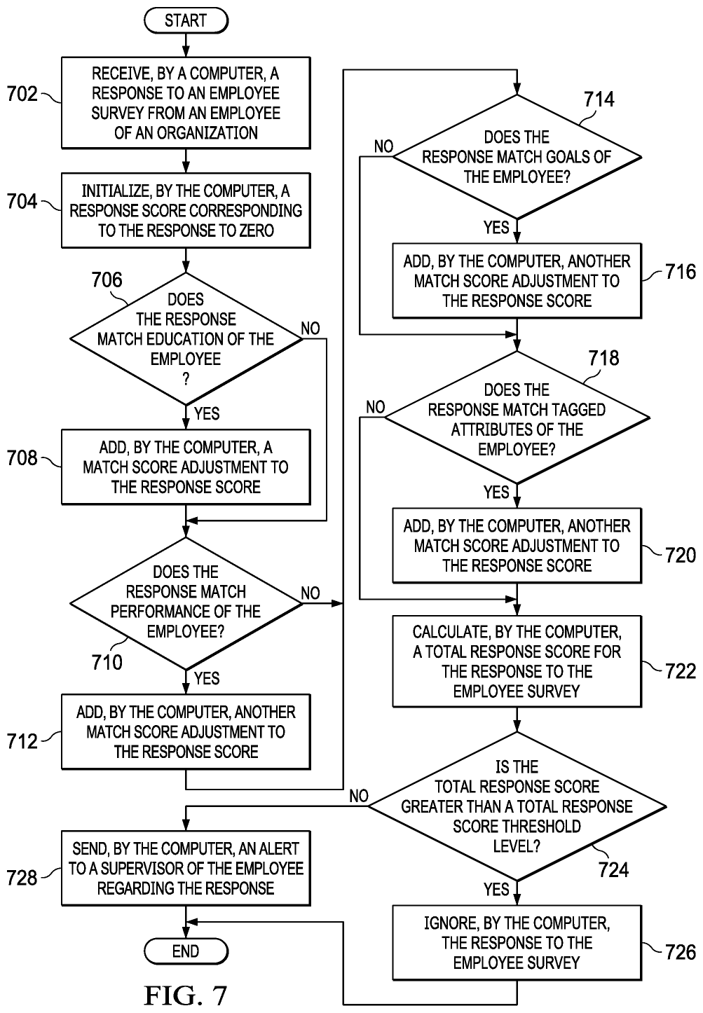

With reference now to FIG. 7, a flowchart illustrating a process for calculating a total employee survey response score based on different aspects corresponding to an employee is shown in accordance with an illustrative embodiment. The process shown in FIG. 7 may be implemented in a computer, such as, for example, server 104 in FIG. 1, data processing system 200 in FIG. 2, or employee survey analysis server 302 in FIG. 3.

The process begins when the computer receives a response to an employee survey from an employee of an organization (step 702). The computer initializes a response score corresponding to the response to zero (step 704). The computer makes a determination as to whether the response matches education of the employee (step 706).

If the computer determines that the response does match the education of the employee, yes output of step 706, then the computer adds a match score adjustment to the response score (step 708). Thereafter, the process proceeds to step 710. If the computer determines that the response does not match the education of the employee, no output of step 706, then the computer makes a determination as to whether the response matches performance of the employee (step 710).

If the computer determines that the response does match the performance of the employee, yes output of step 710, then the computer adds another match score adjustment to the response score (step 712). Thereafter, the process proceeds to step 714. If the computer determines that the response does not match the performance of the employee, no output of step 710, then the computer makes a determination as to whether the response matches goals of the employee (step 714).

If the computer determines that the response does match the goals of the employee, yes output of step 714, then the computer adds another match score adjustment to the response score (step 716). Thereafter, the process proceeds to step 718. If the computer determines that the response does not match the goals of the employee, no output of step 714, then the computer makes a determination as to whether the response matches tagged attributes of the employee (step 718).

If the computer determines that the response does match the tagged attributes of the employee, yes output of step 718, then the computer adds another match score adjustment to the response score (step 720). Thereafter, the process proceeds to step 722. If the computer determines that the response does not match the tagged attributes of the employee, no output of step 718, then the computer calculates a total response score for the response to the employee survey based on totaling match score adjustments (step 722).

The computer makes a determination as to whether the total response score is greater than a total response score threshold level (step 724). If the computer determines that the total response score is greater than the total response score threshold level, yes output of step 724, then the computer ignores the response to the employee survey (step 726). Thereafter, the process terminates. If the computer determines that the total response score is not greater than the total response score threshold level, no output of step 724, then the computer sends an alert to a supervisor of the employee regarding the response (step 728). Thereafter, the process terminates.

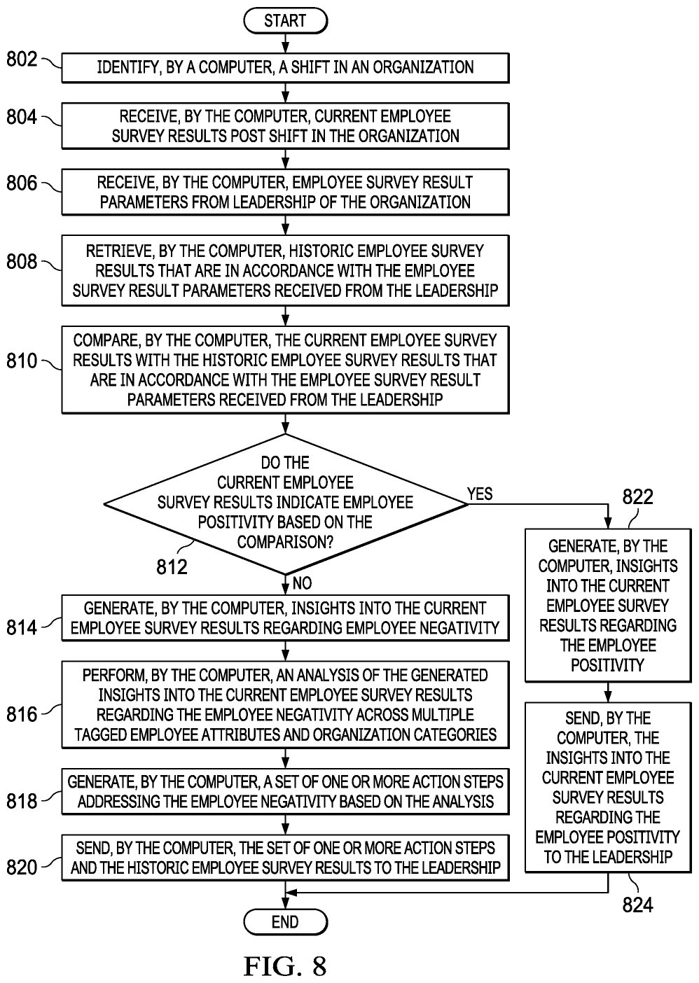

With reference now to FIG. 8, a flowchart illustrating a process for understanding trends in employee survey responses after shifts in an organization is shown in accordance with an illustrative embodiment. The process shown in FIG. 8 may be implemented in a computer, such as, for example, server 104 in FIG. 1, data processing system 200 in FIG. 2, or employee survey analysis server 302 in FIG. 3.

The process begins when the computer identifies a shift in an organization (step 802). The shift in the organization may be, for example, a defined shift in the organization, such as an acquisition, leadership change, business strategy change, financial structure change, and the like. Subsequently, the computer receives current employee survey results after the shift in the organization (step 804).

In addition, the computer, receives a set of employee survey result parameters from leadership of the organization (step 806). Further, the computer retrieves historic employee survey results that are in accordance with the set of employee survey result parameters received from the leadership (step 808). Furthermore, the computer compares the current employee survey results with the historic employee survey results that are in accordance with the set of employee survey result parameters received from the leadership (step 810).

The computer makes a determination as to whether the current employee survey results indicate employee positivity based on the comparison of the current employee survey results with the historic employee survey results (step 812). If the computer determines that the current employee survey results do not indicate employee positivity based on the comparison of the current employee survey results with the historic employee survey results, no output of step 812, then the computer generates insights into the current employee survey results regarding employee negativity (step 814). The insights may be based on, for example, the computer determining that survey result scores were decreased by a predefined amount, such as seven points, for employees having specified tagged attributes, such as technology savvy or innovator, to focus on concerns of these employees.

Moreover, the computer performs an analysis of the generated insights into the current employee survey results regarding the employee negativity across multiple tagged employee attributes and organization categories (step 816). The computer then generates a set of one or more action steps addressing the employee negativity based on the analysis (step 818). The computer sends the set of one or more action steps and the historic employee survey results to the leadership (step 820). Thereafter, the process terminates.

Returning again the step 812, if the computer determines that the current employee survey results do indicate employee positivity based on the comparison of the current employee survey results with the historic employee survey results, yes output of step 812, then the computer generates insights into the current employee survey results regarding the employee positivity (step 822). The computer sends the insights into the current employee survey results regarding the employee positivity to the leadership (step 824). Thereafter, the process terminates.

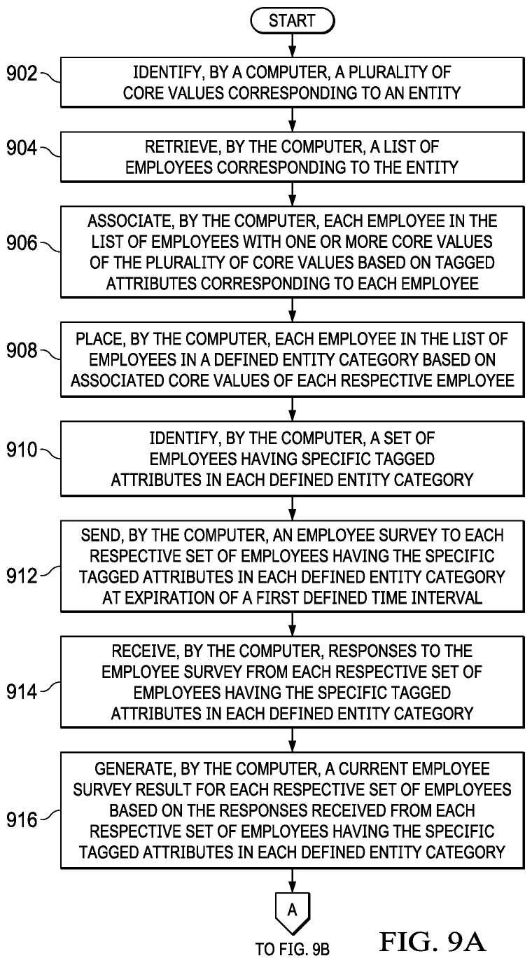

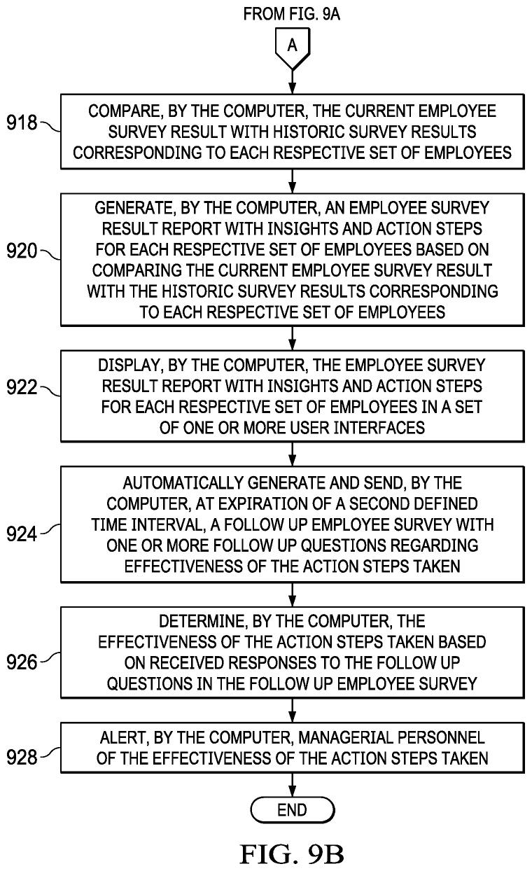

With reference now to FIGS. 9A-9B, a flowchart illustrating a process for generating an employee survey result report is shown in accordance with an illustrative embodiment. The process shown in FIGS. 9A-9B may be implemented in a computer, such as, for example, server 104 in FIG. 1, data processing system 200 in FIG. 2, or employee survey analysis server 302 in FIG. 3.

The process begins when the computer identifies a plurality of core values corresponding to an entity (step 902). The entity may be, for example, a company, a business, an enterprise, an organization, an agency, an institution, or the like. In addition, the computer retrieves a list of employees corresponding to the entity (step 904). The list of employees includes all employees from the lowest-level employee, such as an entry level employee, to the highest-level employee, such as the chief executive officer or president. Further, the computer associates each employee in the list of employees with one or more core values of the plurality of core values based on tagged attributes corresponding to each employee (step 906).

The computer places each employee in the list of employees in a defined entity category based on associated core values of each respective employee (step 908). The computer then identifies a set of employees having specific tagged attributes in each defined entity category (step 910). The computer also sends an employee survey to each respective set of employees having the specific tagged attributes in each defined entity category at expiration of a first defined time interval (step 912).

Subsequently, the computer receives responses to the employee survey from each respective set of employees having the specific tagged attributes in each defined entity category (step 914). The computer generates a current employee survey result for each respective set of employees based on the responses received from each respective set of employees having the specific tagged attributes in each defined entity category (step 916). The computer compares the current employee survey result with historic survey results corresponding to each respective set of employees (step 918).

Afterward, the computer generates an employee survey result report with insights and action steps for each respective set of employees based on comparing the current employee survey result with the historic survey results corresponding to each respective set of employees (step 920). The computer displays the employee survey result report with insights and action steps for each respective set of employees in a set of one or more user interfaces (step 922). It should be noted that the computer may automatically perform one or more of the action steps.

At expiration of a second defined time interval, the computer automatically generates and sends a follow up employee survey with one or more follow up questions regarding effectiveness of the action steps taken (step 924). It should be noted that the computer may not send the follow up employee survey to identical respective sets of employees due to, for example, employee attrition. Then, the computer determines the effectiveness of the action steps taken based on received responses to the follow up questions in the follow up employee survey (step 926). The computer alerts managerial personnel of the determined effectiveness of the action steps (step 928). Thereafter, the process terminates.

Thus, illustrative embodiments of the present invention provide a computer-implemented method, computer system, and computer program product for analyzing survey question responses received from employees having a set of specified employee attributes corresponding to defined entity categories and generating an employee survey result report that includes insights and action steps to address employee concerns noted in the survey question responses and, thereby, decrease employee flight risk. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating insights and action steps based on analyzing employee survey results, the computer-implemented method comprising:
receiving, by a computer, responses to an employee survey of an entity from each respective set of employees having specific tagged attributes in each defined entity category;
generating, by the computer, a current employee survey result for each respective set of employees based on the responses received from each respective set of employees having the specific tagged attributes in each defined entity category;
comparing, by the computer, the current employee survey result with historic survey results corresponding to each respective set of employees;
generating, by the computer, an employee survey result report with insights and action steps for each respective set of employees based on comparing the current employee survey result with the historic survey results corresponding to each respective set of employees; and
displaying, by the computer, the employee survey result report with insights and action steps for each respective set of employees in a set of user interfaces.

2. The computer-implemented method of claim 1 further comprising:
automatically generating and sending, by the computer, at expiration of a defined time interval, a follow up employee survey with one or more follow up questions regarding effectiveness of the action steps taken;
determining, by the computer, the effectiveness of the action steps taken based on received responses to the follow up questions in the follow up employee survey; and
alerting, by the computer, managerial personnel of the effectiveness of the action steps taken.

3. The computer-implemented method of claim 1 further comprising:
identifying, by the computer, a plurality of core values corresponding to the entity;
retrieving, by the computer, a list of employees corresponding to the entity;
associating, by the computer, each employee in the list of employees with one or more core values of the plurality of core values based on tagged attributes corresponding to each employee; and
placing, by the computer, each employee in the list of employees in a defined entity category based on associated core values of each respective employee.

4. The computer-implemented method of claim 1 further comprising:
identifying, by the computer, a set of employees having specific tagged attributes in each defined entity category; and
sending, by the computer, an employee survey to each respective set of employees having the specific tagged attributes in each defined entity category at expiration of a defined time interval.

5. The computer-implemented method of claim 1 further comprising:
tagging, by the computer, an employee with a set of one or more defined attributes based on data corresponding to the employee found in an employee database.

6. The computer-implemented method of claim 1 further comprising:
distributing, by the computer, the employee survey that includes a plurality of questions corresponding to different entity categories to each respective set of employees;
receiving, by the computer, the responses to the employee survey from each respective set of employees;
scoring, by the computer, the responses based on each respective tagged employee attribute and a defined entity category corresponding to each respective tagged employee attribute; and
determining, by the computer, whether a generated score for a particular set of employees having a particular tagged attribute is greater than a score threshold level.

7. The computer-implemented method of claim 6 further comprising:
responsive to the computer determining that the generated score for the particular set of employees having the particular tagged attribute is less than the score threshold level, sending, by the computer, an alert to a defined organization level regarding a low score corresponding to the particular set of employees.

8. The computer-implemented method of claim 1 further comprising:
receiving, by the computer, a response to the employee survey from an employee of the entity;
initializing, by the computer, a response score corresponding to the response to zero;
determining, by the computer, whether the response matches education of the employee;
responsive to the computer determining that the response matches the education of the employee, adding, by the computer, a first match score adjustment to the response score;
determining, by the computer, whether the response matches performance of the employee;
responsive to the computer determining that the response matches the performance of the employee, adding, by the computer, a second match score adjustment to the response score;
determining, by the computer, whether the response matches goals of the employee;
responsive to the computer determining that the response matches the goals of the employee, adding, by the computer, a third match score adjustment to the response score;
determining, by the computer, whether the response matches tagged attributes of the employee;
responsive to the computer determining that the response matches the tagged attributes of the employee, adding, by the computer, a fourth match score adjustment to the response score;
calculating, by the computer, a total response score for the response to the employee survey based on totaling match score adjustments; and
determining, by the computer, whether the total response score is greater than a total response score threshold level.

9. The computer-implemented method of claim 8 further comprising:
responsive to the computer determining that the total response score is less than the total response score threshold level, sending, by the computer, an alert to a supervisor of the employee regarding the response.

10. The computer-implemented method of claim 1 further comprising:
identifying, by the computer, a shift in the entity;
receiving, by the computer, current employee survey results after the shift in the entity;
receiving, by the computer, a set of employee survey result parameters from leadership of the entity;
retrieving, by the computer, historic employee survey results that are in accordance with the set of employee survey result parameters received from the leadership;
comparing, by the computer, the current employee survey results with the historic employee survey results that are in accordance with the set of employee survey result parameters received from the leadership; and
determining, by the computer, whether the current employee survey results indicate employee positivity based on comparison of the current employee survey results with the historic employee survey results.

11. The computer-implemented method of claim 10 further comprising:
responsive to the computer determining that the current employee survey results do not indicate employee positivity based on the comparison of the current employee survey results with the historic employee survey results, generating, by the computer, insights into the current employee survey results regarding employee negativity;
performing, by the computer, an analysis of the insights into the current employee survey results regarding the employee negativity across multiple tagged employee attributes and entity categories;
generating, by the computer, a set of action steps addressing the employee negativity based on the analysis; and
sending, by the computer, the set of action steps and the historic employee survey results to the leadership.

12. The computer-implemented method of claim 11 further comprising:
automatically performing, by the computer, one or more action steps of the set of action steps.

13. A computer system for generating insights and action steps based on analyzing employee survey results, the computer system comprising:
a bus system;
a storage device connected to the bus system, wherein the storage device stores program instructions; and
a processor connected to the bus system, wherein the processor executes the program instructions to:
receive responses to an employee survey of an entity from each respective set of employees having specific tagged attributes in each defined entity category;
generate a current employee survey result for each respective set of employees based on the responses received from each respective set of employees having the specific tagged attributes in each defined entity category;
compare the current employee survey result with historic survey results corresponding to each respective set of employees;
generate an employee survey result report with insights and action steps for each respective set of employees based on comparing the current employee survey result with the historic survey results corresponding to each respective set of employees; and
display the employee survey result report with insights and action steps for each respective set of employees in a set of user interfaces.

14. The computer system of claim 13, wherein the processor further executes the program instructions to:
automatically generate and send, at expiration of a defined time interval, a follow up employee survey with one or more follow up questions regarding effectiveness of the action steps taken;
determine the effectiveness of the action steps taken based on received responses to the follow up questions in the follow up employee survey; and
alert managerial personnel of the effectiveness of the action steps taken.

15. The computer system of claim 13, wherein the processor further executes the program instructions to:
identify a plurality of core values corresponding to the entity;
retrieve a list of employees corresponding to the entity;
associate each employee in the list of employees with one or more core values of the plurality of core values based on tagged attributes corresponding to each employee; and
place each employee in the list of employees in a defined entity category based on associated core values of each respective employee.

16. A computer program product for generating insights and action steps based on analyzing employee survey results, the computer program product comprising a computer readable storage medium having program instructions embodied therewith, the program instructions executable by a computer to cause the computer to perform a method comprising:
receiving, by the computer, responses to an employee survey of an entity from each respective set of employees having specific tagged attributes in each defined entity category;
generating, by the computer, a current employee survey result for each respective set of employees based on the responses received from each respective set of employees having the specific tagged attributes in each defined entity category;
comparing, by the computer, the current employee survey result with historic survey results corresponding to each respective set of employees;
generating, by the computer, an employee survey result report with insights and action steps for each respective set of employees based on comparing the current employee survey result with the historic survey results corresponding to each respective set of employees; and
displaying, by the computer, the employee survey result report with insights and action steps for each respective set of employees in a set of user interfaces.

17. The computer program product of claim 16 further comprising:
automatically generating and sending, by the computer, at expiration of a defined time interval, a follow up employee survey with one or more follow up questions regarding effectiveness of the action steps taken;
determining, by the computer, the effectiveness of the action steps taken based on received responses to the follow up questions in the follow up employee survey; and
alerting, by the computer, managerial personnel of the effectiveness of the action steps taken.

18. The computer program product of claim 16 further comprising:
identifying, by the computer, a plurality of core values corresponding to the entity;
retrieving, by the computer, a list of employees corresponding to the entity;
associating, by the computer, each employee in the list of employees with one or more core values of the plurality of core values based on tagged attributes corresponding to each employee; and
placing, by the computer, each employee in the list of employees in a defined entity category based on associated core values of each respective employee.

19. The computer program product of claim 16 further comprising:
identifying, by the computer, a set of employees having specific tagged attributes in each defined entity category; and
sending, by the computer, an employee survey to each respective set of employees having the specific tagged attributes in each defined entity category at expiration of a defined time interval.

20. The computer program product of claim 16 further comprising:
tagging, by the computer, an employee with a set of one or more defined attributes based on data corresponding to the employee found in an employee database.
